(19) United States
(12) Patent Application Publication
(10) Pub. No.: US 2005/0281414 A1
(43) Pub. Date: Dec. 22, 2005

(54) Method and apparatus for control of personal digital media devices using a vehicle audio system

(76) Inventors: Gregory R. Simon, San Francisco, CA (US); James M. Geier, Montvale, NJ (US)

Correspondence Address: CROWELL & MORING LLP;INTELLECTUAL PROPERTY GROUP, P.O. BOX 14300, WASHINGTON, DC, 20044-4300, US

(21) Appl. No.: 10/870,424

(22) Filed: Jun. 18, 2004

(51) Int. Cl. H04B 1/00

(52) U.S. Cl. 381/86; 700/94

(57) ABSTRACT

A system and method for controlling a personal digital media device is provided, the system and method using the controls of a vehicle audio system. An interface unit receives and translates vehicle audio system control signals and forwards the translated signals in a form interpretable by the personal digital media device for execution. The interface unit may also receive responses from the personal digital media device and forward translated responses to the vehicle audio system for, for example, display in the vehicle audio system's display device. In response to predetermined control signals from the vehicle audio system, the interface unit may command the personal digital media device to playback user-defined playlists named in accordance with a playlist naming convention. The vehicle operator is thus provided an intuitive way to control the personal digital media device remotely via the vehicle audio system's controls, including via steering wheel-mounted audio system controls.

### BACKGROUND OF THE INVENTION

The present invention relates to a method and apparatus for controlling digital media devices, such as a personal audio player, using the controls of a vehicle's built-in audio system and, in particular, using the vehicle audio system's remote controls, such as control buttons on the vehicle's steering wheel.

Personal digital media devices are beginning to replace traditional hard-encoded media, such as cassette audio tapes and compact disks, as the portable personal entertainment device of choice. Such devices receive audio content in a digital format (songs, audiobooks, sound clips, etc.) via download, typically from a user's personal computer. The personal digital media device stores the digital audio in an on-board memory device, such as flash memory or a miniature computer hard drive, and provides the user with a user interface which typically allows the user to access a database to select the content to be played. For example, the user interface may contain an index which allows the user to select audio for playback based on their choice of artist, album, genre, user-defined playlists, or other sorting parameter. Personal digital media devices thus offer virtually unlimited flexibility to the user, both in terms of the content stored on the device, which is selected by the user and can be changed by the user at any time, and in terms of convenient and flexible selection of content to be played (e.g., without needing to advance through a long queue of songs in order to reach a desired audio track).

Personal digital media devices such as the Apple Computer, Inc.'s “iPod” line of audio players, resemble miniature computers in their internal configuration, having a central processing unit (CPU), random access memory and storage memory, and software-based digital control systems to control playback of the audio content stored in the device and to manage the stored audio content database. Typically, these devices include an audio output port into which a user may connect a set of earphones, and a data port, such as a USB or IEEE1394 (aka “Firewire”) port, through which a personal computer can read and write digital audio and database management information to/from the digital device's memory. In addition, many units have a connection which permits the user to add a wired-remote control pad, which permits the user to perform simple audio playback control functions without having to access the device body, for example, to change playback volume, stop/start playback, and advance/reverse (“seek/skip”) through audio tracks. In some cases, such as with the wired remote used with the Apple Computer, Inc. iPods, the wired remote is plugged into the iPod between the earphone connector and the earphones, and the contacts for transmitting playback commands from the wired remote to the iPod are integrated into the iPod's earphone jack.

Personal digital media devices are most frequently used by an individual. The individual carries the device and listens to the audio playback via personal earphone speakers. Increasingly, however, there has been demand to allow the audio to be played back via the music system installed in the user's vehicle. A number of alternatives to accomplish this objective have been developed. For example, there is known a cassette adapter comprising an adapter body inserted into the cassette tape deck of a vehicle's radio, further equipped with a plug which is inserted into the earphone jack of the personal digital media device. When the vehicle's radio is in cassette mode, the audio signal from the personal digital media device is transferred via the adapter to the vehicle's radio and played back on the vehicle's speakers. Similarly, an “FM modulator,” i.e., a low-power FM transmitter, is available which, when plugged into the personal digital media device's earphone jack, broadcasts the audio from the personal digital media device over a frequency received by the vehicle's FM radio receiver. As with the cassette adaptor, once the personal digital media device's audio signal is received by the vehicle radio, it is played back on the vehicle's speakers.

While these adapters provide a way for audio from a personal digital media device to be played back over a vehicle's built-in radio system, these approaches are significantly limited by their ability to receive and forward only audio signals to the vehicle for audio playback. As a result, in order to control the functions of the personal digital media device (e.g., select audio tracks for playback or determine which track is currently playing) the user must still keep the personal digital media device within reach, and at least at times within sight, while operating the vehicle. The acts of retrieving the device from its resting place within the vehicle interior, viewing the device display (and the often difficult to read small characters therein) and manipulating the device's small control buttons can be very demanding of the user's concentration, even when the vehicle is not operating. When combined with driving, concentration on retrieving and operating the personal digital media device can result in the vehicle operator becoming very distracted and failing to maintain proper attention to safe operation of the vehicle, thereby compromising the safety of the vehicle operator and those in the vicinity of the vehicle. Wired remote controls do not solve these problems, as they themselves promote distraction by requiring the operator to retrieve and operate the remote controller. Remote controllers also typically offer little or nothing in the way of display capability, so viewing the personal digital media device is still required for control of any device functions beyond simple volume, pause/run, or sequential track changes.

In recent years, vehicle audio systems have been developed with components which not only transmit and receive audio signals among one another, but also transmit and receive commands and data in digital form, typically over wires or other conduits (such as optical fiber) which are separate from the conduits conducting audio signals. For example, a central audio component (usually a stereo “head unit”) may contain a control protocol with which the head unit can communicate with, for example, a separate CD changer. The “I-Bus” communications protocol employed by some BMW vehicle audio systems is an example of such a control protocol. With appropriate control software conforming the protocol, the radio head unit may issue commands to peripheral components to execute functions such as verifying a CD changer's compatibility with the head unit (a so-called “electronic handshake”), retrieve CD track information (artist, song title, etc.) for display in view of the vehicle driver, and control CD changer operation (e.g., disc and track selection).

Notwithstanding the development of digital control protocols for use between components in a built-in vehicle audio system, personal digital media devices previously have not included means of receiving or responding to such protocols. Moreover, even if a means is provided for responding and to vehicle audio system protocols is provided, there remains significant issues with regard to intuitive and convenient selection of audio content from the personal digital media device.

Many personal digital media devices are microprocessor-based devices containing software which presents a user with a system of hierarchal menus through which the user must pass in order to select the digital content to be played by the device. These menu systems impose a high cognitive load on the user. When this cognitive load is superimposed on the demanding environment of operating a vehicle, the operator may become cognitively overloaded, to the point of distraction from safe operation of the vehicle.

A separate issue is the inherent mismatch between vehicle audio system capabilities for intuitive control of peripheral devices and the capacity and capabilities of personal digital media devices. It is well known to have a vehicle audio system configured to support and control peripheral components such as CD changers with limited audio content, for example, a 6-CD changer being controlled at the audio system control panel with six CD selection buttons (typically the six buttons will also serve as radio pre-set buttons when in AM/FM mode). In contrast, today's personal digital media devices may contain several thousand audio tracks. While the prior arrangements of six CD selection buttons provided an inherently intuitive and convenient approach to audio selection which minimized the opportunity for operator distraction (e.g., one-button operation for virtually instantaneous selection and playback of a desired audio from a CD), there is no equivalent intuitive and convenient audio selection approach for selection and playback of personal digital media device content which is compatible with existing vehicle audio systems. Thus, there is a need for a method and system with an improved human-machine interface which permits control of personal digital media devices in an intuitive and convenient manner to select and play audio content while minimizing driver distraction from the task of safely operating the vehicle.

### SUMMARY OF THE INVENTION

In view of the foregoing, it is an objective of the present invention to provide the ability for a built-in vehicle media system, including a vehicle audio system, to remotely command and control the functions of a personal digital media device, wherein a human-machine interface enables selection and playback of desired content from a personal digital media device with maximum convenience and minimal distraction from vehicle operation. It is a further objective of the present invention to provide the ability to control the functions of the personal digital media device from a vehicle audio system's remote controls, such as the vehicle's steering-wheel-mounted fingertip audio system controls.

The foregoing objectives are accomplished by providing a system interface between a vehicle digital media system and a personal digital media device, wherein the device responds to operating commands and queries to its internal databases which are translated by the interface mechanism. The interface mechanism, in addition to providing the usual media signal pass-through (e.g., passing left and right stereo audio signals from a source to the vehicle's head unit), is capable of receiving commands and database queries from a built-in vehicle audio system, issuing appropriate commands or queries to the personal digital media device, and transmitting information received from the personal digital media device to the vehicle audio system in accordance with the system's digital bus control protocol. Further, the interface mechanism is adapted, for example, via programming in an on-board microprocessor, to translate commands corresponding to vehicle audio system control buttons, such as CD selection buttons, to commands to the personal digital media device to select and playback user-defined audio selections, such as “playlists” (i.e., user-defined listings of audio tracks associated with one another under a command identifier).

The personal digital media device may have a port or other means for exchanging digital information with the interface mechanism and contain appropriate software for responding to received commands and queries. An example of a personal digital media device which contains an appropriate communications port is the Apple Computer, Inc.'s so-called “third generation” iPod devices. The third generation iPod is equipped with additional computer software providing the device with additional functionality as compared to prior personal digital media devices, including the ability to receive external commands and permit external access to information contained in the databases within the iPod over a serial “UART” port (universal asynchronous receive/transmit port). In a specific embodiment, appropriate software has been developed to permit the third generation iPod to communicate with an interface mechanism which in turn can communicate with a BMW vehicle audio system employing the I-bus control protocol. One advantage of the new iPod functionality is its ability to scale up its information output from small single-line display devices up to a MOST (media oriented system transport)-enabled ½ VGA HMI (video graphics array human/machine interface).

With this combination of interface mechanism, appropriately-programmed third generation iPod, and an I-bus BMW vehicle audio system, the operator using this embodiment of the present invention may control the third generation iPod remotely via the vehicle audio system's controls, including via steering wheel-mounted audio system controls, and view information from the iPod on the vehicle audio system displays (such as track title), without the need to see or touch the personal digital media device.

The present invention thus greatly reduces operator distraction and enhances convenient operation of entertainment equipment in a vehicle. In addition, by providing for the display of information associated with control of the personal digital media device and the content of the personal digital media device on a vehicle audio system control display that is fixed in the vehicle interior and located near the vehicle operator's line of sight, operator distraction is greatly minimized. The present invention further provides for control of the personal digital media device with existing audio system controls to minimize or eliminate the need to remove the operator's hands from the vehicle controls, thereby eliminating distractions associated with retrieving and operating the personal digital media device. The present invention also permits the personal digital media device to be secured in a location, such as a compartment, which is out of view to deter theft and which eliminates the potential for the personal digital media device to become a projectile hazard during a vehicle collision.

From a suppliers viewpoint, utilizing an existing vehicle media system control protocol with an interface mechanism and built-in personal digital media device control functionality offers significant cost savings, as existing control protocols need little or no revision to support personal digital media device control and information display, and avoids the need for expensive and complicated development of an interface mechanism with IEEE 1394 or USB compatibility. Thus, a very inexpensive interface device with minimal programming and components may be used. For example, one embodiment may contain only a circuit-board, three physical connectors (one each of a vehicle audio connector, a vehicle control protocol connector, and a personal digital media device connector), and semi-conductors devices providing the protocol translator and protocol interface functions.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic block diagram of a system, including a vehicle media system, and interface unit and a personal digital media device, in accordance with an illustrative embodiment of the present invention.

FIG. 2 is schematic diagram illustrating an interface mechanism in accordance with the embodiment of the present invention shown in FIG. 1.

FIG. 3 is diagram illustrating playlist selection with vehicle media system controls via an interface mechanism in accordance with the embodiment of the present invention shown in FIG. 1.

### DETAILED DESCRIPTION OF THE DRAWINGS

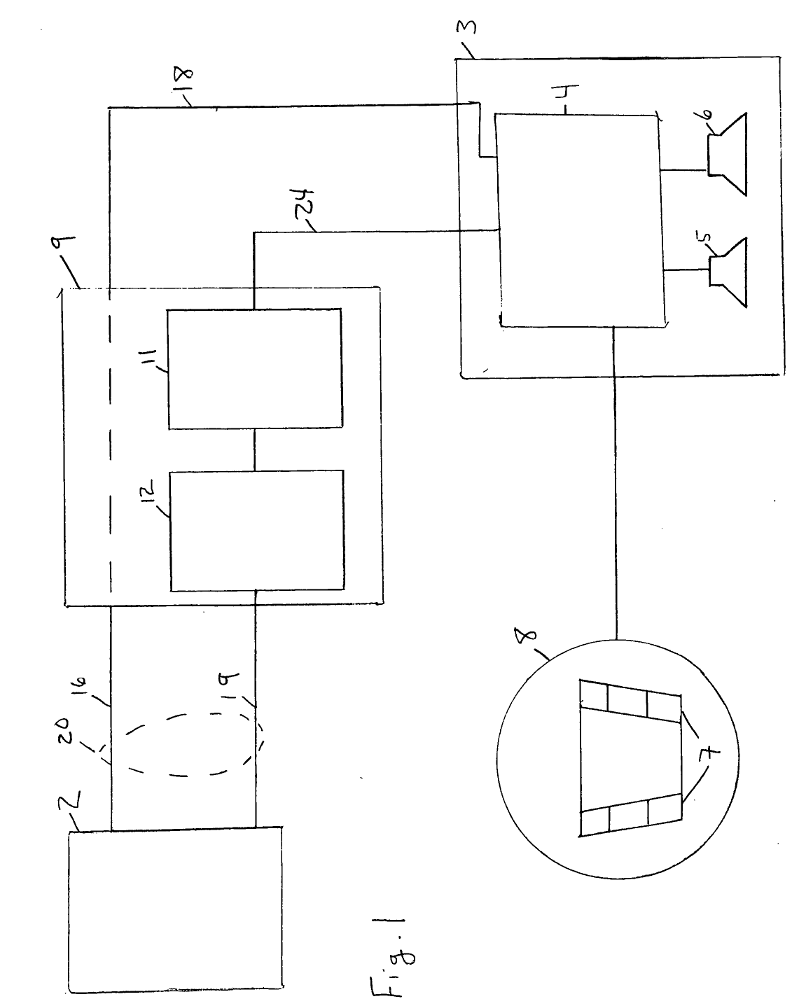

FIG. 1 provides a schematic overview of one embodiment of an integrated system 1 incorporating a personal digital media device 2 (a third generation Apple iPod in this embodiment, also referred to below as iPod 2) and a vehicle digital audio system 3 in accordance with the present invention. The vehicle audio system 3 includes a stereo head unit 4 located in the dash panel of the vehicle and containing, among other system components, a display panel, operator controls, an audio signal amplifier, and a central processing unit and software operating with the I-bus control system protocol. The software is encoded in microcircuits (i.e., firmware) in the present embodiment, but need not be so fixed. In addition, the head unit 4 is equipped with external connectors for, for example, receipt of audio signals from external audio components, transfer of digital data and commands on a digital bus linking the head unit 4 with other components in the audio system, and outputting analog audio signals to vehicle speakers 5, 6. The vehicle audio system also includes remote steering wheel controls 7 mounted on steering wheel 8. The head unit 4 may also have an external connector which allows information to be forwarded to a remote display unit (not shown) which is more conveniently observed by the operator.

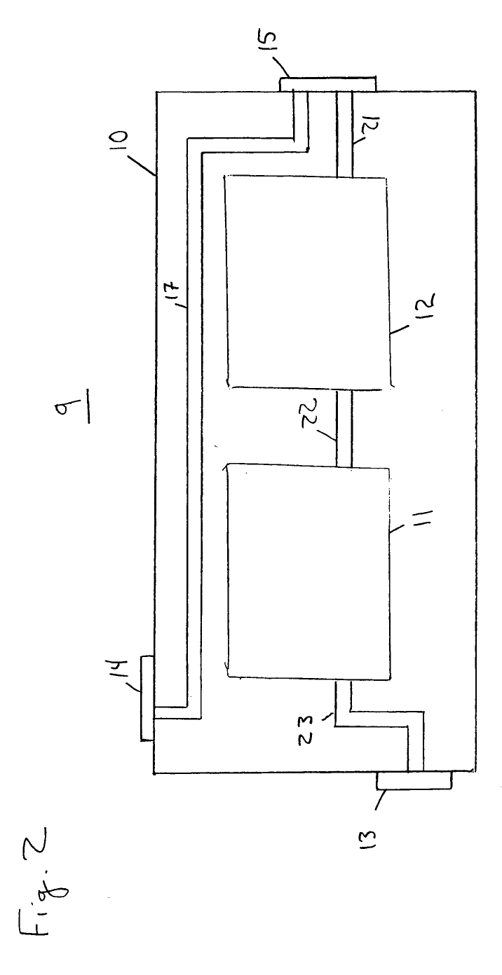

Between the head unit 4 and the personal digital media device 2 is an interface device 9, which is shown in greater detail in FIG. 2. In this embodiment, the interface device 9 is based on a standard glass-fiber circuit board 10 which is populated by microcircuit devices 11, 12 and connectors 13, 14 and 15. Microcircuit 11 provides a communications interface between the interface device 9 and the communications bus operated by the head unit 4 using the BMW I-bus protocol. Microcircuit 12 provides a protocol translator to translate commands and database queries from head unit 4 (transferred via communications interface microcircuit 11) to commands and queries compatible with the personal digital media device 2, forward the translated commands and queries to the personal digital media device 2, and translate and return responses from the personal digital media device 2 to head unit 4 (via communications interface microcircuit 11).

The personal digital media device 2, vehicle audio system 3 and interface device 9 are connected in the following manner. Line-level audio output from personal digital media device 2 is transmitted via conduit 16, in this embodiment a three-wire audio lead, to interface device 9. Conduit 16 connects to connector 15 on interface device 9, and its audio signals are passed through interface device 9 on printed conductor traces 17 to pass-through audio connector 14. The audio signals then pass via conduit 18 to the vehicle audio system 3, and specifically to head unit 4.

Digital commands, database queries and responses (collectively, “control or data signals”) travel on the following path. Data conduit 19 connects the UART port (not shown) of the personal digital media device 2 to connector 15. Both the audio conduit 16 and data conduit 19 are combined into a single application-specific cable 20 which connects to connector 15. The digital control or data signals pass between connector 15 and protocol translator microcircuit 12 across printed conductor traces 21, between protocol translator microcircuit 12 and communications interface microcircuit 11 across printed conductor traces 22, and between communications interface microcircuit 11 and connector 13 across printed conductor traces 23. The control or data signals between head unit 4 and the interface device connector 13 are transferred on conduit 24.

In the present embodiment, the interface device 9 effectively presents the personal digital media device 2 to the I-bus-equipped head unit 4 as having the functionality of a multi-disc CD changer for which the head unit 4 is already programmed to control under the existing I-bus control protocol. Thus, the head unit 4 may request, receive and display information from the personal digital media device 2 similar to that available from a compatible CD changer, such as artist name, track title, device identification. The head unit 4 may also issue commands in response to operation of user-interface controls (e.g., control buttons) similar to the commands available for control of the compatible CD changer, such as scan on/off, repeat on/off, start/pause, and preset button selection. For example, the interface device 9 may map head unit buttons 1-6, typically used to select CDs in a 6-CD changer, to commands to be sent to the iPod for execution. In one mode, for example, buttons 1-6 may be mapped to user-defined “playlists” 1-6 stored in the iPod 2 such that when button “4” on head unit 4 is depressed, the iPod begins to send the audio output associated with a playlist on the iPod defined as “playlist 4” back through conduit 16 to head unit 4 for playback over speakers 5 and 6. Specifically, in this embodiment the interface device 9 firmware is programmed such that when it receives a command from the head unit 4 corresponding to CD selection button “1,” the interface device commands the iPod 2 to play a user-defined playlist of audio content that the user has pre-labeled on the iPod 2 as “BMW1( . . . )” (where the ellipses refer to any user-desired label characters which follow the four-character “BMW#” portion of the playlist name). Similarly, if the second head unit CD selection button is depressed, in response the interface device 9 will command the iPod 2 to play the playlist “BMW2( . . . ).” Alternatively or in addition, the interface device 9 may be programmed to command other functions of the iPod. For example, in response to a operation of a head unit 4 “Fast Forward” control, the interface device 9 may command, via the iPod's UART port, that iPod 2 skip forward in the present audio track, or skip forward to the beginning of the next track. Other possibilities include programming the interface device to command, in response to operation of other pre-determined head unit 4 controls (or combination of controls), random play of audio content, sequential play by alphabetic artist name, play the next or the previous playlist or audiobook. Thus, without having to modify the existing I-bus protocol, highly flexible and intuitive control of the personal digital media device may be achieved by way of the translations provided by interface device 9.

In operation, the personal digital media device interfaces with the vehicle audio system in the following manner. When the operator selects audio input from the iPod (personal digital media device) 2, either with controls on head unit 4 or remote control buttons 7 on steering wheel 8, a command to start the personal digital media device 2 is forwarded from the head unit 4 via its I-bus connection to communications interface microcircuit 11, through protocol translator microcircuit 12, and to the iPod 2.

In response to the start command received via the iPod's UART port, the control programs in the iPod activate the iPod (e.g., take the iPod out of “pause” mode). The iPod 2 may respond to the start command by providing its owner-defined identification information for display in the vehicle audio system display (for example, “JOHNSPOD”), or if previously connected with the head unit 4, an alpha-numeric indication of the audio track currently qued for play, e.g., “2-34,” corresponding to track 34 of user-defined iPod playlist “BMW2( . . . ).” If an audio track was being played when the iPod was previously paused, it may resume playing, i.e., being output to conduit 16. Once the presence of iPod 2 is recognized by the I-bus-equipped head unit 4 (via the interface unit 9 translation), the head unit 4 may then pass the audio output received from the iPod 2 to speakers 5, 6. In general, operation of a vehicle audio system control, such as a control button on a steering wheel, results in the iPod responding by changing its operating state, e.g., starting audio playback, skipping forward, or pausing.

In this embodiment, at anytime after the presence of the iPod 2 is recognized by the head unit 4, database queries may be issued to the iPod 2 via interface 9 to retrieve content identifying information and information useful for navigating the iPod's content for display to the operator. The interface device 9 translates the head unit 4's queries, which correspond to information request protocols already existing in the I-bus protocol for obtaining such information from an I-bus compatible CD changer, and provides the queries to the iPod 2. The iPod 2 software then executes the requested database query and returns the result via conduit 19 to interface device 9 for translation and forwarding to head unit 4 via the I-bus protocol.

Due to the minimal resource demands on interface unit 9 (in the present embodiment, less that 5000 bytes of ROM and 500 bytes of RAM required to implement an I-bus communications stack), an iPod UART protocol and the associated translation services), the interface device may be manufactured at very low cost with relatively unsophisticated electronic components, with a very small finished product size, on the order of the size of a third generation iPod.

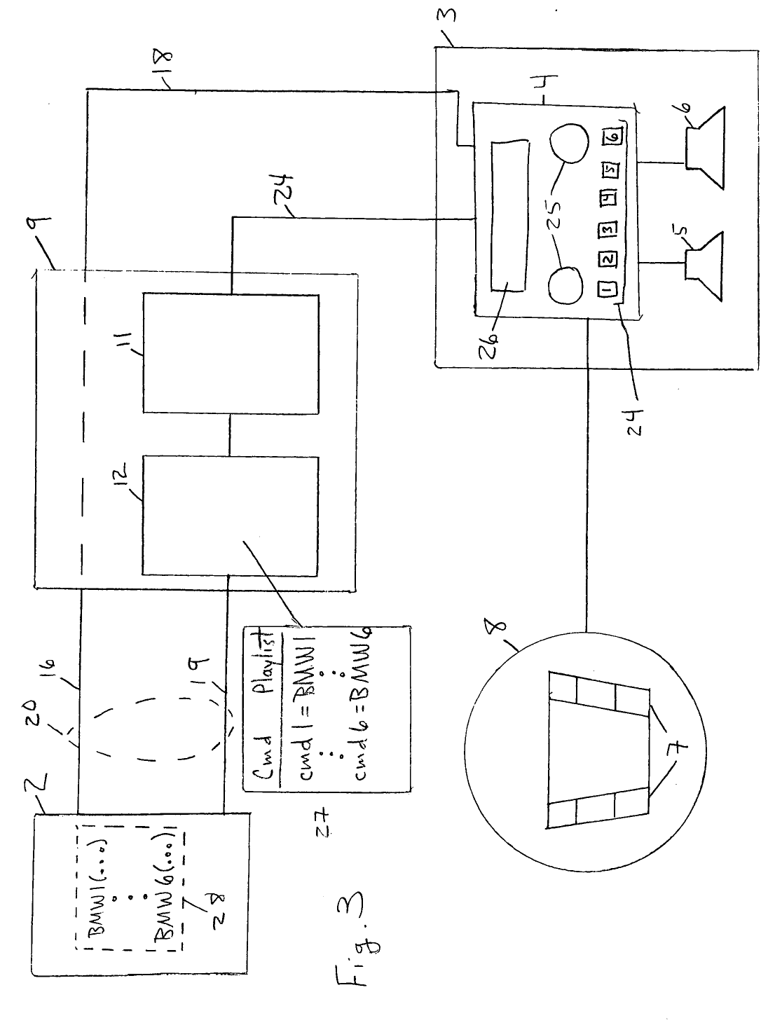

FIG. 3 illustrates an embodiment of the present invention in which playlists in the personal digital media device 2 may be accessed for playback from the vehicle audio system controls of via interface device 9. In this embodiment, head unit 4 has an array of six multi-function pushbuttons 24 in addition to other audio controls 25, such as system volume control and radio tuning rotary knobs. The six pushbuttons 24 may be assigned different functions depending on the current mode of the radio, such as radio pre-sets in FM radio mode, or CD selection when in CD changer mode with a 6-CD changer connected to the audio system. When an device such as an iPod 2 is connected to the audio system and the corresponding operating mode is selected (which may be indicated in a display panel 26 of head unit 4), the six pushbuttons 24 may be assigned, and control playlist playback in the following manner.

In order to playback a playlist in the embodiment shown in FIG. 3, the operator may depress a pushbutton corresponding to a desired playlist, in this example, pushbutton 1. Head unit 4 issues a bus command to interface device 9 via conduit 24 to communications interface microcircuit 11. The command is processed by microcircuit 11, and forwarded to protocol translator microcircuit 12 for translation into a form which iPod 2 can recognize. In this case, the bus protocol command corresponding to pushbutton 1 is translated, for example by reference to a look-up table 27 programmed into microcircuit 12, to a command containing the name of a playlist conforming to a predetermined playlist naming convention. In this example, the predetermined naming convention is “BMWx”, where “x” corresponds to the selected pushbutton on head unit 4. The interface device 9 then forwards the translated playback command to iPod 2. On receipt of the command, iPod 2's operating software determines whether a playlist whose first four name characters are “BMW1” created by the iPod user is present in the media device's memory 28. If the desired playlist is present, iPod 2 begins to playback the BMW1 playlist through conduits 16 and 18 to head unit 4. The iPod 2 may also return current playlist and track-playing information (for example, “1-34” corresponding to current playback of track 34 in playlist BMW1) via interface device 9 for display in display panel 26.

The foregoing disclosure has been set forth merely to illustrate the invention and is not intended to be limiting. For example, the vehicle media system may include video devices, and the personal digital media device may include a video playback device such as a DVD player. Similarly, the invention is not restricted to use with existing digital control protocols in vehicle entertainment systems, but may be used with control protocols provided with additional functionality, including additional functionality added specifically to facilitate enhanced control of a specific personal digital media device. Accordingly, since modifications of the disclosed embodiments incorporating the spirit and substance of the invention may occur to persons skilled in the art, the invention should be construed broadly to include everything within the scope of the appended claims and equivalents thereof.

1. A control system, comprising:
a vehicle media system, the vehicle media system including a control system for interacting with peripheral media equipment;
a personal digital media device; and
an interface unit coupled between the vehicle media system and the personal digital device,
wherein the interface unit receives control signals comprising at least one of command signals and database query signals from the vehicle media system and forwards said control signals to the personal digital media device in a form interpretable by the personal digital media device, and
further wherein the interface unit responds to predetermined vehicle media system control signals by forwarding control signals to the personal digital media device to command the personal digital media device to return user-defined selections of media content for playback to the vehicle media system.

2. The system of claim 1,
wherein the vehicle media system control system uses a digital communications bus protocol, and
wherein the interface unit includes electronics which translate signals from the vehicle's digital bus control protocol to signals interpretable by the personal digital media device.

3. The system of claim 2, wherein predetermined vehicle media system control signals correspond to vehicle media system user-interface controls.

4. The system of claim 3, wherein the vehicle media system user-interface controls correspond to peripheral media equipment controls.

5. The system of claim 4, wherein the vehicle media system controls include at least one of CD selection and CD track navigation controls.

6. The system of claim 3,
wherein the user-defined selections of media content include at least one user-defined playlist of content,
wherein the at least one user-defined playlist conforms to a predetermined playlist naming convention, and
wherein the interface device is programmed such that, in response to operation of one of the vehicle media system user-interface controls corresponding to one of the at least one user-defined playlists, the interface device commands playback of the selected playlist by forwarding a control signal which includes a playlist name portion conforming to the predetermined playlist naming convention to the personal digital media device.

7. The system of claim 6,
wherein the user-defined selections of media content further includes at least one predetermined personal digital media device playback mode, said playback mode including at least one of random content playback and sequential content playback modes, and
wherein the interface device is programmed such that, in response to operation of one of the vehicle media system user-interface controls corresponding to one of the predetermined playback modes, the interface device forwards a control signal to the personal digital media device to playback content in accordance with the predetermined playback mode corresponding to the user-interface control selected by the operator.

8. The system of claim 3, wherein the vehicle media system includes at least one of controls on a dashboard interface and on a vehicle steering wheel for controlling issuing of at least one of said signals to the personal digital media device.

9. The system of claim 6, wherein the vehicle media system includes at least one of controls on a dashboard interface and on a vehicle steering wheel for controlling issuing of at least one of said signals to the personal digital media device.

10. The system of claim 7, wherein the vehicle media system includes at least one of controls on a dashboard user interface and on a vehicle steering wheel for controlling issuing of said signals to the personal digital media device.

11. The system of claim 6, wherein the vehicle media system is a vehicle audio system.

12. An interface unit for interfacing a personal digital media device with a vehicle media system to permit remote control of the personal digital media device by the vehicle media system, comprising:
an interface unit bus connection between the vehicle media system and an interface bus communications circuit; and
an interface unit device connection between the personal digital media device and an interface protocol translation circuit,
wherein the interface bus communications circuit and the interface protocol translation circuit are electronically coupled,
wherein the interface protocol translation circuit translates control signals comprising command signals and data query signals received through the interface bus communications circuit from the vehicle media system to a form interpretable by the personal digital media device, and
further wherein the interface unit responds to predetermined vehicle media system control signals by forwarding control signals to the personal digital media device to command the personal digital media device to return user-defined selections of media content for playback to the vehicle media system.

13. The system of claim 12, wherein predetermined vehicle media system control signals correspond to vehicle media system user-interface controls.

14. The system of claim 13,
wherein the user-defined selections of media content include at least one user-defined playlist of content,
wherein the at least one user-defined playlist conforms to a predetermined playlist naming convention, and
wherein the interface device is programmed such that, in response to operation of one of the vehicle media system user-interface controls corresponding to one of the at least one user-defined playlists, the interface device commands playback of the selected playlist by forwarding a control signal which includes a playlist name portion conforming to the predetermined playlist naming convention to the personal digital media device.

15. The system of claim 14,
wherein the user-defined selections of media content further includes at least one predetermined personal digital media device playback mode, said playback mode including at least one of random content playback and sequential content playback modes, and
wherein the interface device is programmed such that, in response to operation of one of the vehicle media system user-interface controls corresponding to one of the predetermined playback modes, the interface device forwards a control signal to the personal digital media device to playback content in accordance with the predetermined playback mode corresponding to the user-interface control selected by the operator.

16. A method for controlling a personal digital media device, comprising the acts of:
connecting a personal digital media device to a vehicle media system with an interface unit:
receiving with the interface unit a control signal comprising at least one of a command signal and a database query signal from the vehicle media system;
forwarding the received control signal from the interface unit to the personal digital media device in a form interpretable by the personal digital media device; and
commanding, in response to receipt of predetermined vehicle media system control signals by the interface unit, the personal digital media device to return user-defined selections of media content for playback to the vehicle media system.

17. The method of claim 16, wherein predetermined vehicle media system control signals correspond to vehicle media system user-interface controls.

18. The method of claim 17,
wherein the user-defined selections of media content include at least one user-defined playlist of content,
wherein the at least one user-defined playlist conforms to a predetermined playlist naming convention, and
wherein in the act of commanding the personal digital media device to return user-defined selections of media content for playback, the interface device commands playback of the selected playlist by forwarding a control signal which includes a playlist name portion conforming to the predetermined playlist naming convention to the personal digital media device.

19. The method of claim 18, further comprising the act of:
selecting playback of one of the user-defined playlists by operation of vehicle media system controls on at least one of a dashboard interface and on a vehicle steering wheel.

20. The method of claim 18,
wherein the user-defined selections of media content further includes at least one predetermined personal digital media device playback mode, said playback mode including at least one of random content playback and sequential content playback modes, and
wherein the interface device is programmed such that, in response to operation of one of the vehicle media system user-interface controls corresponding to one of the predetermined playback modes, the interface device forwards a control signal to the personal digital media device to playback content in accordance with the predetermined playback mode corresponding to the user-interface control selected by the operator.
